(19) United States
(12) Patent Application Publication
(10) Pub. No.: US 2006/0238647 A1
(43) Pub. Date: Oct. 26, 2006

(54) VIDEO DATA PROCESSING METHOD AND DEVICE FOR AMPLIFIED DYNAMIC VIDEOS

(75) Inventor: Yu-Chou Lee, Hu Nei Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: VIHONOR OPTO-ELECTRONICS CO., LTD., Gangshan Chen (TW)

(21) Appl. No.: 10/908,045

(22) Filed: Apr. 26, 2005

(51) Int. Cl. H04N 9/12; G09G 5/00

(52) U.S. Cl. 348/383; 345/1.3

(57) ABSTRACT

A video data accessing method and device which perform loading actions and saving actions respectively in two stages, wherein the loading or saving actions depend on whether the received video signal contains valid data. When the received data is valid, only the saving action is performed to a register at each clock cycle, at the same time the register will not be read.

### BACKGROUND OF THE INVENTION

1. Field of the invention

The invention relates to a video data processing method and device for amplified dynamic video, more particularly the method and the device that ensure the amplified videos displayed on a television wall can remain high in resolution and saturated color.

2. Related Art

For a television wall consisting of multiple televisions, an analog video amplifying device is connected between the televisions and an incoming video signal for amplifying the signal. The incoming video signal input to the amplifying device has the same standard as a video signal received by the television, i.e. the AV signal and S signal. After the AV/S signals have passed through the amplifying device, the amplified signals then contain significant analog noises that may cause obvious differences in color among the televisions.

As the conventional analog video amplifying technique may result in ill effects to the displaying quality, researchers start to compare diverse video signals to find their differentiation. The study results show the VGA signal has representation superior to the AV/S signal in resolution and color saturation. Therefore, after the AV/S signal has been converted to an RGB signal, the problem of poor color saturation is much worse. As a result, the VGA video signal output from a VGA card of the computer is adopted as the source signal for the amplifying device. Because the incoming video signal has been altered, this VGA amplifying device accordingly has circuits different to the conventional amplifying device.

Because earlier televisions were only equipped with an AV/S terminal to receive video data, the amplifying device had to convert the original incoming VGA signal to the AV/S signal to be output to the television. However, the AV/S signal still has different colors to the VGA signal after the converting processes.

For a new proposed computer-controlled television wall that can directly receive the VGA signal, an amplifying device suitable for the television wall is expensive due to high manufacturing cost. The amplifying device needs a time to amplify the received original VGA signal to fit the television wall, so a register is required to temporarily store the incoming data.

With reference to FIG. 8, a processor in the amplifying device loads the data to be processed from the register, determines whether the loaded data is valid, and then saves the valid data. In other words, the processor performs data loading and saving actions in a complete clock cycle, wherein the processor loads the data from the register in the early half clock cycle (rising edge) and saves the valid data in the later half clock cycle (falling edge). In general, the processor must be operated at a high speed to convert and amplify the received video data. If the operating clock frequency of the micprocessor is fixed, saving the valid data and loading the data from the register must be simultaneously proceeded as soon as the data is determined to be valid. Thus, the frequency of the operating clock of the register must be at least twice faster than that of the processor.

For example, when the operating frequency of the processor is 15.75 ns and a 60 MHz video signal with 1024×768 resolution is to be processed, the operating frequency of the register should be 7.8 ns. However, when adopting the most commonly used 10 ns asynchronous SRMA, it still causes the image delay problem on the screen.

Although the computer-controlled television wall can provide the amplified signal with superior quality, the data processing problem of the amplifying device is unfavorable to improving displaying resolution. The need for a fast operating frequency register will further increases the fabricating cost.

For the above reasons, there is a need to provide a novel data processing method and device for the dynamic images to mitigate and solve the problems.

### SUMMARY OF THE INVENTION

An objective of the present invention is to provide a video data processing method that ensures videos can be displayed with a high resolution and saturated color without need of an expensive and high operating speed register.

The method performs video data loading actions and video data saving actions respectively in two stages, wherein the loading or saving actions depend on whether the received video signal contains valid data. When the received data is determined to be valid, only saving the valid data to a register is performed at each clock cycle, and at the same time the register will not be read. Therefore, the operating clock cycle of the register does not need to be twice as fast as that of the processor. In other words, a inexpensive register with normal operating clock cycle can be adopted.

To accomplish the objective, the video data processing device provides:

a processor providing functions including data accessing, valid video data determining and video amplifying;

a signal converting unit connected between the processor and a digital video source for converting a digital video source signal to a digital signal with a level acceptable for the processor;

a register connected to the processor for temporarily storing video data accessed by the processor; and

a digital to analog (D/A) converter connected between an output terminal of the processor and a display for converting an amplified video signal output from the processor to a VGA signal.

The processing device can further comprise a video signal switching unit coupled between the signal converting unit and multiple digital video sources, wherein the video signal switching unit selects one of the multiple digital video sources and outputs the selected digital video source to the signal converting unit.

The video signal switching unit further comprises:

a multiplexer having multiple input terminals and an output terminal, wherein the output terminal of the multiplexer is connected to the signal converting unit; and

multiple signal converters, wherein each signal converter has an input terminal to receive a respective digital video source and has an output terminal connected to a respective input terminal of the multiplexer.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a video data processing device according to a first embodiment of the present invention.

FIG. 2 is a block diagram of a video data processing device according to a second embodiment of the present invention.

FIG. 3 is a block diagram of a video data processing device according to a third embodiment of the present invention.

FIG. 4 is a block diagram in which multiple video data processing devices of FIG. 2 are connected as a sequence to control multiple displays.

FIG. 5 is a block diagram in which multiple video data processing devices of FIG. 3 are connected as a sequence to control multiple displays.

FIG. 6 is a block diagram in which video data processing devices are connected to form multiple groups for controlling the displays of a television wall.

FIG. 7 is a timing chart showing how a processor accesses a register in accordance with the present invention.

FIG. 8 is a timing chart showing how a processor accesses a register in accordance with prior art.

### DETAILED DESCRIPTION OF THE PREFERRED EMBODIMENT

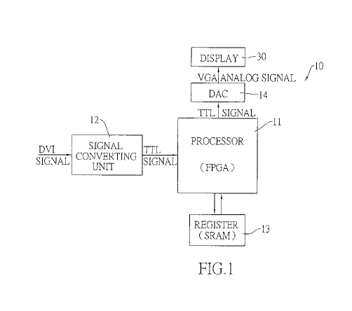

With reference to FIG. 1, a video data processing device (10) according to a first embodiment of the present invention comprises a processor (11), a signal converting unit (12), a register (13) and a digital to analog (D/A) converter (14).

The processor (11) provides multiple functions such as data accessing, valid video data determining and video amplifying.

The signal converting unit (12) is connected between the processor (11) and a digital video source for converting a digital video interactive (DVI) signal to a digital TTL signal with a level acceptable for the processor (11). The processor (11) can be a field programmable gate array (FPGA) with transistor-transistor logic (TTL) signal level standard.

The register (13) is connected to the processor (11) for temporarily storing data accessed by the processor (11). The register (13) can be a static random access memory (SRAM).

The D/A converter (14) is connected between an output terminal of the processor (11) and a display (30) equipped with a VGA terminal.

The DVI signal received by the signal converting unit (12) is amplified by the processor (11) and output to the D/A converter (14). The D/A converter (14) transforms the amplified signal to a VGA signal for presenting on the display (30) with high resolution and superior color saturation.

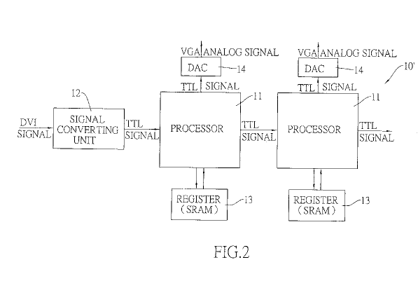

With reference to FIG. 2, a video data processing device (10′) according to a second embodiment is suitable for connecting multiple displays (30) each equipped with a VGA terminal. The device (10′) comprises multiple processors (11), a signal converting unit (12), multiple registers (13) and D/A converters (14).

The multiple processors (11) are connected as a series, wherein each processor (11) can provide multiple functions such as data accessing, valid video data determining and video amplifying. Each processor (11) can be a field programmable gate array (FPGA) with transistor-transistor logic (TTL) signal level standard.

The signal converting unit (12) is connected between the first processor (11) and a digital video output terminal for converting a digital video interactive (DVI) signal to a signal with a level acceptable for the processor (11).

Each register (13) is connected to a respective processor (11), for temporarily storing data accessed by the processor (11). The register (13) can be a static random access memory (SRAM).

Each D/A converter (14) is connected between an output terminal of a respective processor (11) and a respective display (30).

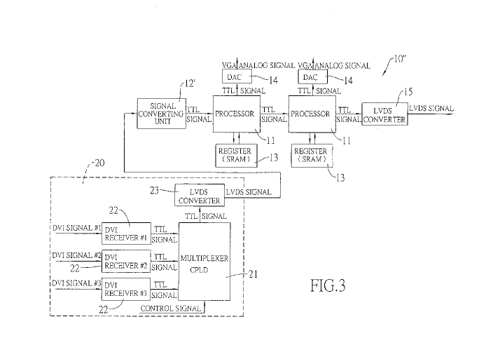

With reference to FIG. 3, in another embodiment of the present invention, the video data processing device (10″) is a commination of a video signal switching unit (20) and the video data processing device (10′) of FIG. 2. The video signal switching unit (20) comprises a multiplexer (21), and multiple signal converters (22) as well as an optional low voltage differential signal (LVDS) converter (23).

The output terminals of all the signal converters (22) are connected to input terminals of the multiplexer (21). An output terminal of the multiplexer (21) is connected to the signal converting unit (12′) of the video data accessing device (10″). The multiplexer (21) can be formed by a complex programmable logic device (CPLD). A desired video signal can be selected and supplied to the signal converting unit (12′) from the different digital signals (DVI1, DVI2, DVI3) by applying a control signal to the multiplexer (21). For the purpose of image quality improvement, the LVDS converter (23) can be connected to the output terminal of the multiplexer (21) to transform the TTL video signal to an LVDS signal. Consequently, the signal converting unit (12′) has to transform the LVDS signal to a TTL signal.

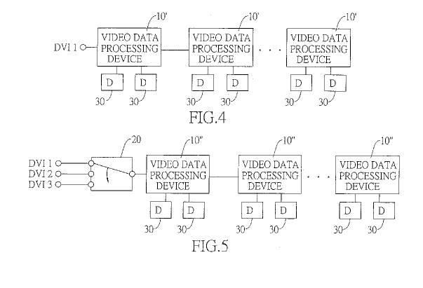

As discussed above, the video data accessing device can be applied to the television wall consisting of multiple displays. With reference to FIG. 4, multiple video data processing devices (10″) are connected as a sequence to receive a single video signal. When manufacturing such video data processing device, two or three processors, signal converters and registers can be formed on the same circuit board. Since the multiple processors are connected in series, a processor at the last stage on the circuit boards is further connected to an LVDS converter (15) (as shown in FIG. 3) to be connected to the signal converting unit (12′) of a subsequent circuit board.

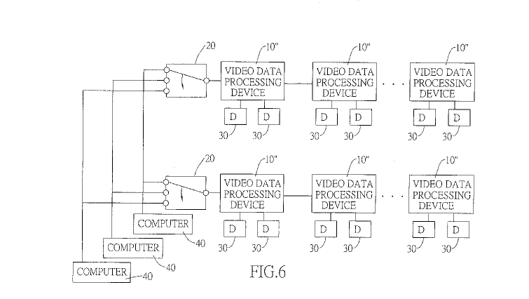

With reference to FIG. 5, such configuration is applied to choose a video signal from different video signal sources by using the switching unit (20). Further, as shown in FIG. 6, the video data processing devices (10″) are connected to form multiple groups, where the video data processing devices (10″) contained in each group are connected in series. This configuration is also suitable for the multiple video signals, where each video signal is supplied by an individual computer (40).

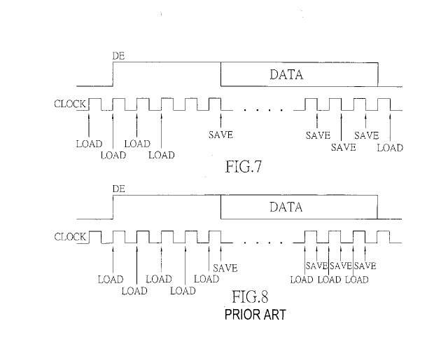

With reference to FIG. 7, during the video amplifying processes, the received video data is firstly stored in the register (13) and then read by the processor (11). The video data accessing method in accordance with the present invention mainly comprises two stages where the loading actions and saving actions are performed in a respective stage. To load or save data depends on whether the received data is valid. When the received data is valid, only the saving action is performed at each clock cycle in which the data in the register (13) will not be read. Therefore, the video data processing device can utilize the inexpensive register to reduce manufacturing cost.

The processes performed by the processor (11) can be concluded to the steps as following:

loading a digital video signal;

determining whether the digital video signal contains valid video data;

only saving the valid video data to a register if the valid video data are detected; and

reading the valid video data saved in the register and amplifying the valid video data according to an amplifying multiple.

In conclusion, the video data accessing method of the present invention purposely separates the reading and saving actions upon the existence of valid data. In comparison with the prior art that performs reading and saving actions in each clock cycle, inexpensive registers can be adopted in the present invention. Even for the application of high resolution display, the amplifying processes can remain operating at high speed without experiencing any delay problem. Further, since both the input signal and output signal of the amplifying device are the VGA standard, the chromatic aberration problem can be avoided.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A video data processing device comprising:
a processor providing functions including data accessing, valid video data determining and video amplifying;
a signal converting unit connected between the processor and a digital video source for converting a digital video source signal to a digital signal with a level acceptable for the processor;
a register connected to the processor for temporarily storing video data accessed by the processor; and
a digital to analog (D/A) converter connected between an output terminal of the processor and a display for converting an amplified video signal output from the processor to a VGA signal.

2. The video data processing device as claimed in claim 1, wherein when the processor executes the data accessing function, the processor loads the digital signal, determines whether the digital signal contains valid video data, only saves the valid video data to a register if the valid video data are detected, and reads the valid video data saved in the register and amplifies the valid video data according to an amplifying multiple.

3. The video data processing device as claimed in claim 1, wherein the processing device further comprises a video signal switching unit coupled between the signal converting unit and multiple digital video sources, wherein the video signal switching unit selects one of the multiple digital video sources and outputs the selected digital video source to the signal converting unit.

4. The video data processing device as claimed in claim 3, wherein the video signal switching unit comprises:
a multiplexer having multiple input terminals and an output terminal, wherein the output terminal of the multiplexer is connected to the signal converting unit; and
multiple signal converters, wherein each signal converter has an input terminal to receive a respective digital video source and has an output terminal connected to a respective input terminal of the multiplexer.

5. The video data processing device as claimed in claim 4, wherein the signal converting unit converts the digital video source signal to the digital signal with a transistor-transistor logic (TTL) level standard acceptable for the processor.

6. The video data processing device as claimed in claim 4, wherein the video signal switching unit further comprises a low voltage differential signal (LVDS) converter connected to the output terminal of the multiplexer for converting a TTL signal output from the multiplexer to an LVDS signal, wherein the signal converting unit further converts the LVDS signal to a TTL signal.

7. The video data processing device as claimed in claim 1, wherein the signal converting unit converts the digital video source signal to the digital signal with a TTL level standard.

8. The video data processing device as claimed in claim 4, wherein the multiplexer is a complex programmable logic device (CPLD).

9. The video data processing device as claimed in claim 1, wherein the processor is a fixed programmable gate array (FPGA).

10. A video data processing device comprising:
multiple processors connected in series, each processor providing functions including data accessing, valid video data determining and video amplifying;
a signal converting unit connected between a first processor and a digital video source for converting a digital video source signal to a digital signal with a level acceptable for the processor;
multiple registers, each register connected to a respective processor for temporarily storing video data accessed by the processor; and
multiple digital to analog (D/A) converters, each D/A converter connected between an output terminal of a respective processor and a display for converting an amplified video signal output from the processor to a VGA signal.

11. The video data processing device as claimed in claim 10, wherein when the processor executes the data accessing function, the processor loads the digital signal, determines whether the digital signal contains valid video data, only saves the valid video data to a register if the valid video data are detected, and reads the valid video data saved in the register and amplifies the valid video data according to an amplifying multiple.

12. The video data processing device as claimed in claim 10, wherein the processing device further comprises at least one video signal switching unit coupled between the signal converting unit and multiple digital video sources, wherein the video signal switching unit selects one of the multiple digital video sources and outputs the selected digital video source to the signal converting unit.

13. The video data processing device as claimed in claim 12, wherein the video signal switching unit comprises:
a multiplexer having multiple input terminals and an output terminal, wherein the output terminal of the multiplexer is connected to the signal converting unit; and
multiple signal converters, wherein each signal converter has an input terminal to receive a respective digital video source and has an output terminal connected to a respective input terminal of the multiplexer.

14. The video data processing device as claimed in claim 13, wherein the signal converting unit converts the digital video source signal to the digital signal with a transistor-transistor logic (TTL) level standard acceptable for the processor.

15. The video data processing device as claimed in claim 13, wherein the video signal switching unit further comprises a low voltage differential signal (LVDS) converter connected to the output terminal of the multiplexer for converting a TTL signal output from the multiplexer to an LVDS signal, wherein the signal converting unit further converts the LVDS signal to a TTL signal.

16. The video data processing device as claimed in claim 10, wherein the signal converting unit converts the digital video source signal to the digital signal with a TTL level standard.

17. The video data processing device as claimed in claim 13, wherein the multiplexer is a complex programmable logic device (CPLD).

18. The video data processing device as claimed in claim 10, wherein the processor is a fixed programmable gate array (FPGA).

19. A video data processing method for amplified dynamic video, comprising the steps of:
loading a digital video signal;
determining whether the digital video signal contains valid video data;
only saving the valid video data to a register if the valid video data are detected without any reading actions to the register; and
reading the valid video data saved in the register.
